(19) United States
(12) Patent Application Publication
(10) Pub. No.: US 2005/0240669 A1
(43) Pub. Date: Oct. 27, 2005

(54) BIOS framework for accommodating multiple service processors on a single server to facilitate distributed/scalable server management

(76) Inventors: Rahul Khanna, Beaverton, OR (US); Mallik Bulusu, Olympia, WA (US); Vincent J. Zimmer, Federal Way, WA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025, US

(21) Appl. No.: 10/811,755

(22) Filed: Mar. 29, 2004

(51) Int. Cl. G06F 15/173

(52) U.S. Cl. 709/225

(57) ABSTRACT

BIOS framework for accommodating multiple service processors on a single server to facilitate distributed/scalable server management. During a pre-boot phase for a server, information is collected pertaining to service capabilities supported by each of a plurality of service processors used to service server management requests for a server, wherein the services supported by each service processor are performed via execution of service code associated with that service processor. The service capabilities are aggregated across all of the service processors, and a corresponding unified presentation of service capabilities is provided to a service consumer. End-users are enabled to provide preferences that define a usage order for like services hosted by different service processors within the same system. The BIOS framework can detect the addition or removal of hot-swap cards hosting one or more service processors and associated service code, and update the unified presentation of service capabilities to reflect new added service capabilities or remove previously existing service capabilities.

### FIELD OF THE INVENTION

The field of invention relates generally to computer systems and, more specifically but not exclusively relates to a BIOS framework for accommodating multiple service processors on a single server to facilitate distributed/scalable server management.

### BACKGROUND INFORMATION

As computer server architectures have advanced, more specific functionality have been added to meet customer needs and to increase uptime. For example, older computer server architectures might employ a single processor that is use to provide substantially all server functionality via execution of firmware and software instructions on the processor, as well as through specific hardware-level logic built into the processor and/or platform. More recently, the single point of service has been discarded for a more distributed service scheme, whereby multiple processors are employed to perform targeted functions.

For example, modern servers may employ an “out-of-band” management controller that performs separate functions than the servers' primary processor (or processors for multi-processor platforms). Typically, an out-of-band management controller comprises an independent processor, such as a base management controller (BMC) or service processor, connected to various hardware components of a server platform to monitor the functionality of those hardware components. For instance, a service processor may be configured to have its own independent link to a network with an independent Internet protocol (“IP”) address to allow an administrator on a remote console to monitor the functionality of the server. As used herein, these processors are collectively termed “service processors.”

With reference to FIG. 1, a server 100 having a conventional service processor configuration known in the art is depicted. The illustrated embodiment of server 100 includes a service processor 102, a main processor (CPU) 104, a communication interface 106, a data storage unit 108, a service processor firmware storage device 110, and a platform firmware storage device 112. Main processor 104 is communicatively coupled to various platform components via one or more buses that are collectively illustrated as a system bus 114. Typically, service processor 102 is coupled to the same and/or different platform components via an independent bus and/or direct channels, also called service channels; this bus or buses is depicted in FIG. 1 as a management bus 116. In one embodiment, service processor 102 is communicatively-coupled to communication interface 106 via a separate channel 118. Optionally, the coupling may be implemented via management bus 116.

Generally, service processor 102 may be linked in communication with a network 120 via either communication interface 106 or a dedicated network interface. In the illustrated embodiment, communication interface 106 provides two ports with respective IP addresses of IP₁ and IP₂, whereby one IP address may be used by main processor 104, while the other may be used by service processor 102

An administrator working on a remote console 120 coupled to network 122 can monitor the functionality of main processor 104, data storage unit 108, or other entities (not shown) via interaction with service processor 102. The functions of service processor 102 generally include monitoring one or more characteristics or operations of main processor 104 (e.g., monitoring the temperature of processor 104), data storage unit 108, and other hardware components (not shown), recording hardware errors, performing manual tasks initiated by the administrator (such as resetting main processor 104), recovering main processor 104 after an error, performing manual input/output data transfers, and the like. The functions are collectively depicted as services 124

The foregoing service processor functions are enabled via execution of firmware stored in service processor firmware storage device 110. In particular, interaction with the various hardware components is provided via one or more corresponding firmware drivers. At the same time, separate firmware drivers stored in platform firmware storage device 112 are employed by main processor 104 to access the same hardware components.

While the conventional scheme supports the potential of a wide-range of services, it isn't scalable. This is problematic. For example, the choice of service processor (and associated firmware) for a given platform design is always a challenge, as the server management requirements vary drastically from customer to customer. One may want to employ a light-weight service processor to minimize costs. On the other hand, a customer may want to opt for a full-blown BMC implementation on high-end servers. It would be advantageous to have a flexible and scalable service management solution to mitigate the foregoing limitations with conventional service management implementation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a conventional server architecture that includes support for implementing a single service processor;

FIG. 2 is a schematic diagram of a scalable server management framework that includes support for concurrent implementation of multiple service processors, and provides a unified presentation of service capabilities to service consumers, according to one embodiment of the invention;

FIG. 3 is a flowchart illustrating operations and logic performed during a pre-boot phase of a server having the architecture of FIG. 2 to setup up a BIOS unified presentation table and publish a BIOS-based server management handler, according to one embodiment of the invention;

FIG. 4 is a is a schematic diagram illustrating the various execution phases that are performed in accordance with the extensible firmware interface (EFI) framework under which the operations of the platform initialization process of FIG. 3 may be performed, according to one embodiment of the invention;

FIG. 5 is a block schematic diagram illustrating various components of the EFI system table corresponding to the EFI framework;

FIG. 6 is a schematic diagram illustrating further details of how services are enumerated and published under the EFI framework;

FIG. 7 is a schematic diagram of a server having an architecture based on the scalable server management framework of FIG. 2 that is enabled to provide data to render a unified presentation of service capabilities on a remote control used by an administrator to request and observer server management services.

FIG. 8 is a representation of a user interface rendered on the remote console that enables an end-user to make preferences identifying a usage order of service processors that support the same service; and

FIG. 9 is a flowchart illustrating operations performed during a server management event that is serviced by selecting an appropriate service processor, according to one embodiment of the invention.

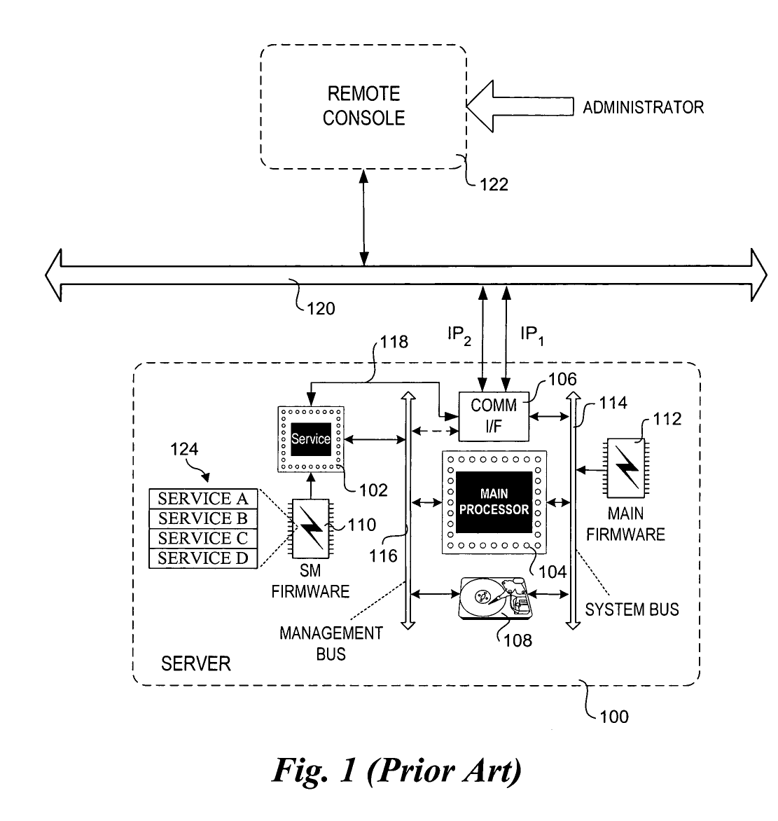

### DETAILED DESCRIPTION OF PREFERRED EMBODIMENTS

Embodiments of a BIOS framework for accommodating multiple service processors on a single server to facilitate distributed/scalable server management are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification and in the claims, several terms of art are used. These terms are to take on their ordinary meaning in the art from which they come, unless specifically defined herein (such as follows) or the context of their use would clearly suggest otherwise. BIOS (Basic Input-Output System) refers to the system firmware (i.e., executable instructions) that is employed to facilitate low-level interfacing with platform hardware. As used herein, the terms “BIOS” and “firmware” may be used interchangeably.

The use of the term “service processor” and services supported by the service processor are often implied herein. However, it will be understood that a service processor does not perform services by itself, but rather performs services via execution of “service code” associated with the service processor.

In accordance with aspects of the embodiments described herein, a BIOS-based framework that facilitates scalability of server management operations is disclosed. The framework enables various server management components, such as commercial off-the-shelf (COTS) server management hardware solutions, to be added to servers to achieve scalability. To accommodate distributed/scalable server management, the framework generates a BIOS Unified Presentation (BUP) of overall server management service capabilities available to consumers of server management services. The framework enables server management components to be added, removed and/or replaced, with any new or removed service capabilities supported by new platform configurations reflected by updating the BUP. The framework also provides a single point interface to all consumers of server management services.

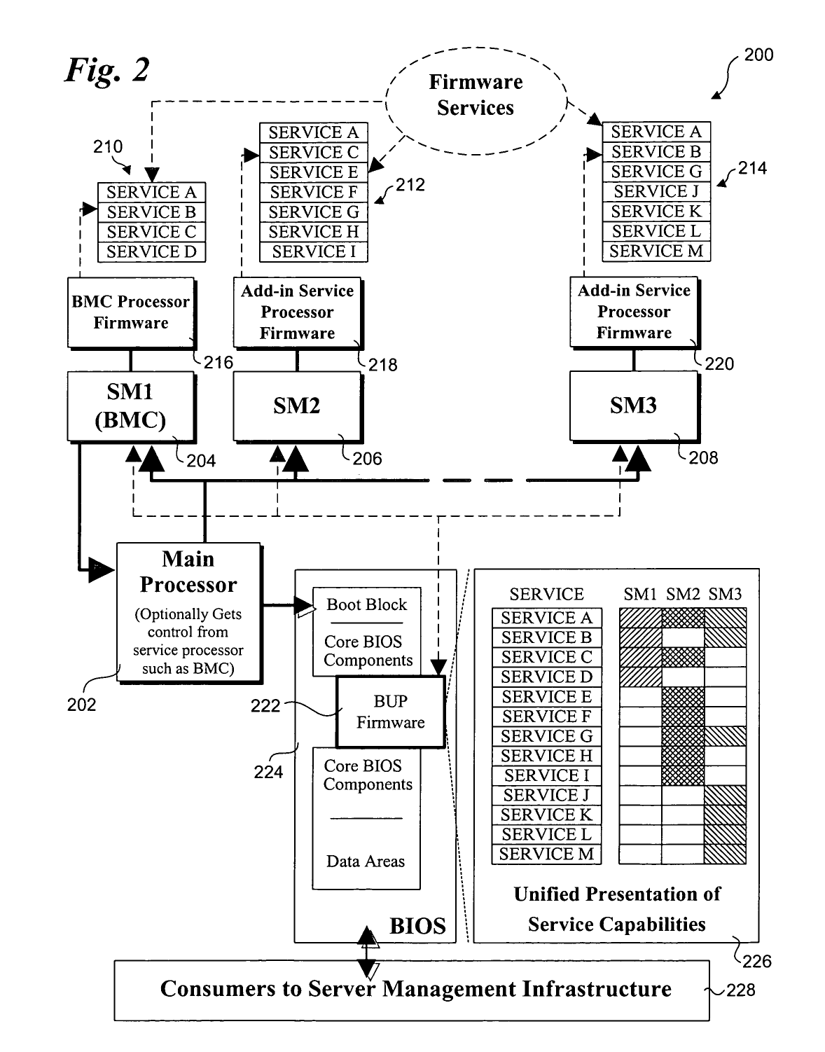

An overview illustrating a scalable server management framework 200 according to one embodiment is shown in FIG. 2. In one embodiment of the framework, a main processor 202 is communicatively-coupled to one or more service processors via a management bus or the like. In the illustrated embodiment, these include service processors 204, 206, and 208. (For convenience, these service processors are labeled SM1, SM2, and SM3, respectively.) In one embodiment, service processor 204 comprises a BMC. In one embodiment, a service management processor may perform the interface functions described below that are depicted in FIG. 2 as being performed by main processor 202.

In general, a typical server implementation may include one service processor, such as a BMC, that is built into the main or baseboard of the server. Additional service processors, such as depicted by service processors 206 and 208, are provided by add-in cards that are connected to expansion slots provided by the baseboard or communicatively-coupled via a shared backplane or the like. As such, these service processors are also referred to herein as “add-in” service processors. In some embodiments, the server may be configured as a blade server, which may include one or more shared backplanes.

Each of the service processors provides a set of services via execution of corresponding service code. The services shown for service processors 204, 206, and 208 are depicted as service sets 210, 212 and 214, respectively. In one embodiment, each service is facilitated by a corresponding firmware component (i.e., set of instructions comprising service code) that is executed by the service processor hosting the service. In the illustrated embodiment of FIG. 2, this firmware is depicted as BMC processor firmware 216, add-in service processor firmware 218, and add-in service processor firmware 220.

In one embodiment, the BUP functionality is facilitate by a firmware component depicted as BUP firmware 222. In the illustrated embodiment, this firmware component is stored as part of the platform's system BIOS 224. As described below, the BUP firmware may be stored elsewhere on the baseboard, or may be loaded from an add-in card or even from a network store.

The BUP firmware maintains a BUP table 226. The BUP table maps an aggregated set of services provided by the various service processors present in a system to services offered by those service processors. This supports a unified presentation of the service capabilities to server management service consumers for the system. In one embodiment, BUP-related information is provided to such consumers via consumers to server management infrastructure 228, which represents an abstraction of all of the interfaces that enable server management service consumers to access the service facilities for the system.

Under the framework illustrated in FIG. 2, firmware facilities are implemented to manage the BUP and handle interfacing with service consumers. To support this functionality, the service capabilities for each service processor are collected by BUP firmware 222. In one embodiment, this is accomplished via a service processor registration process. Under the process, a firmware driver for each service processor registers its instance to the BUP during the initialization phase for the driver. Each service processor also publishes its service capabilities to the BUP via corresponding interfaces. Through this mechanism, the BUP captures an active list of service processors and their service capabilities (via execution of associated service code) at any given time.

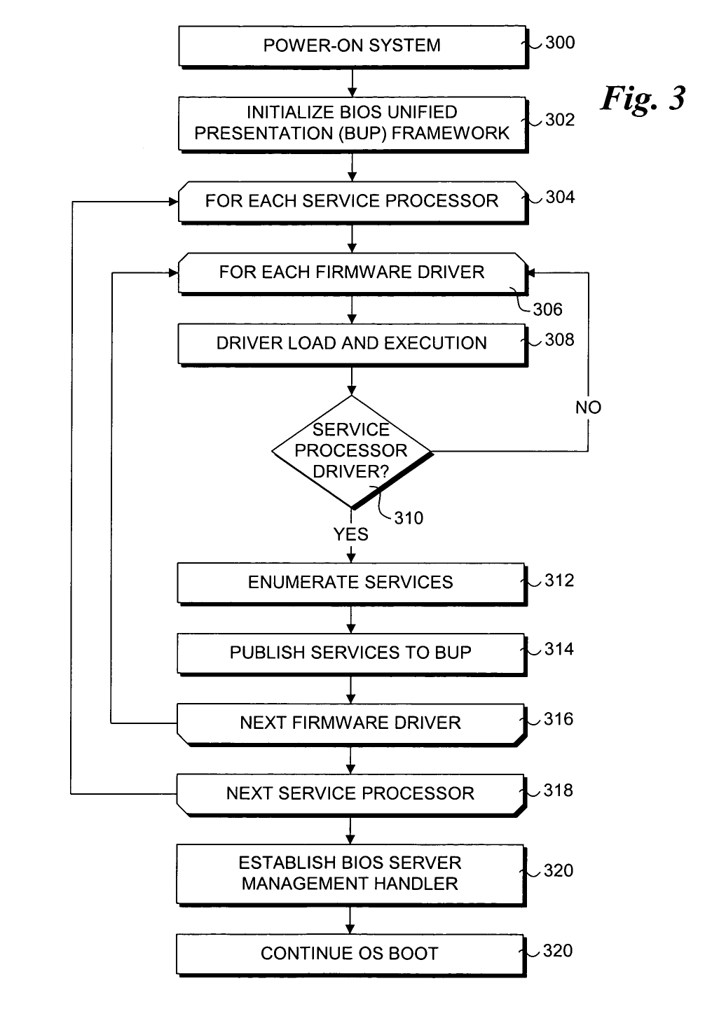

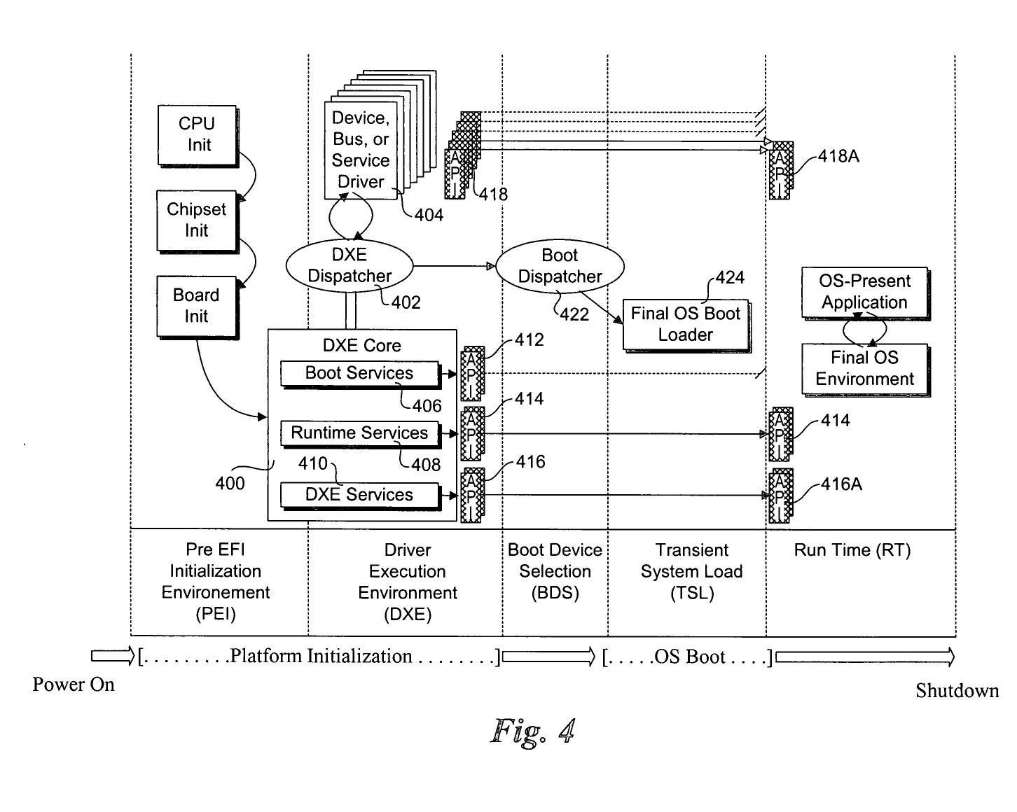

A general overview of a service processor registration process, according to one embodiment, is now presented with reference to the flowchart of FIG. 3. Further details of a more-specific implementation of this process depicted in FIGS. 4, 5, and 6 follows.

Referring to FIG. 3, the registration process begins with a power-on event (or system reset), as depicted in a block 300. In response, firmware initialization operations are performed during a pre-boot phase to verify the operational integrity of the system and prepare the system for loading an operating system. Included in this process is initialization of the BUP framework in a block 302. The next set of nested operations are performed for each service processor and each firmware driver for that service processor, as depicted by outside loop start and end loop blocks 304 and 318, and inside loop start and end loop blocks 306 and 316.

In a block 306 each firmware driver is loaded and/or executed during the pre-boot phase of the server. This includes registering an instance of each firmware driver. Depending on the particular driver, the corresponding firmware may be used only for initialization, or may set up interfaces for use during operating system (OS) runtime. As indicating by a decision block 310, if the driver is a service processor driver, the logic proceeds to a block 312. In this block, the services supported via the service processor driver are enumerated. The enumerated services are then published to the BUP. The operations of blocks 308, 310, 312, and 314 are repeated until all the firmware drivers for the system have been loaded and/or executed.

Subsequently, a BIOS server management handler is established in a block 320. The handler is used to provide an interface to server management consumers, as described in further detail below. At the close of the registration process, the pre-boot initialization of the system continues, with the operating system being booted in a block 320.

In accordance with one embodiment, the foregoing service processor registration process may be implemented under an extensible firmware framework known as the Extensible Firmware Interface (EFI) (specifications and examples of which may be found at http://developer.intel.com/technology/efi). EFI is a public industry specification that describes an abstract programmatic interface between platform firmware and shrink-wrap operation systems or other custom application environments. The EFI framework include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks. The current EFI framework specification is entitled, “Intel Platform Innovation for EFI Architecture Specification,” version 0.9, Sep. 16, 2003.

FIG. 4 shows an event sequence/architecture diagram used to illustrate operations performed by a platform (e.g., server) under the EFI framework in response to a cold boot (e.g., a power off/on reset). The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 400, the DXE dispatcher 402, and a set of DXE drivers 404. The DXE core 400 produces a set of Boot Services 406, Runtime Services 408, and DXE Services 410. The DXE dispatcher 402 is responsible for discovering and executing DXE drivers 404 in the correct order. The DXE drivers 404 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any CPU-specific, chipset specific, or platform specific information. Instead, the DXE core is abstracted from the system hardware through a set of architectural protocol interfaces. These architectural protocol interfaces are produced by DXE drivers 104, which are invoked by DXE Dispatcher 102.

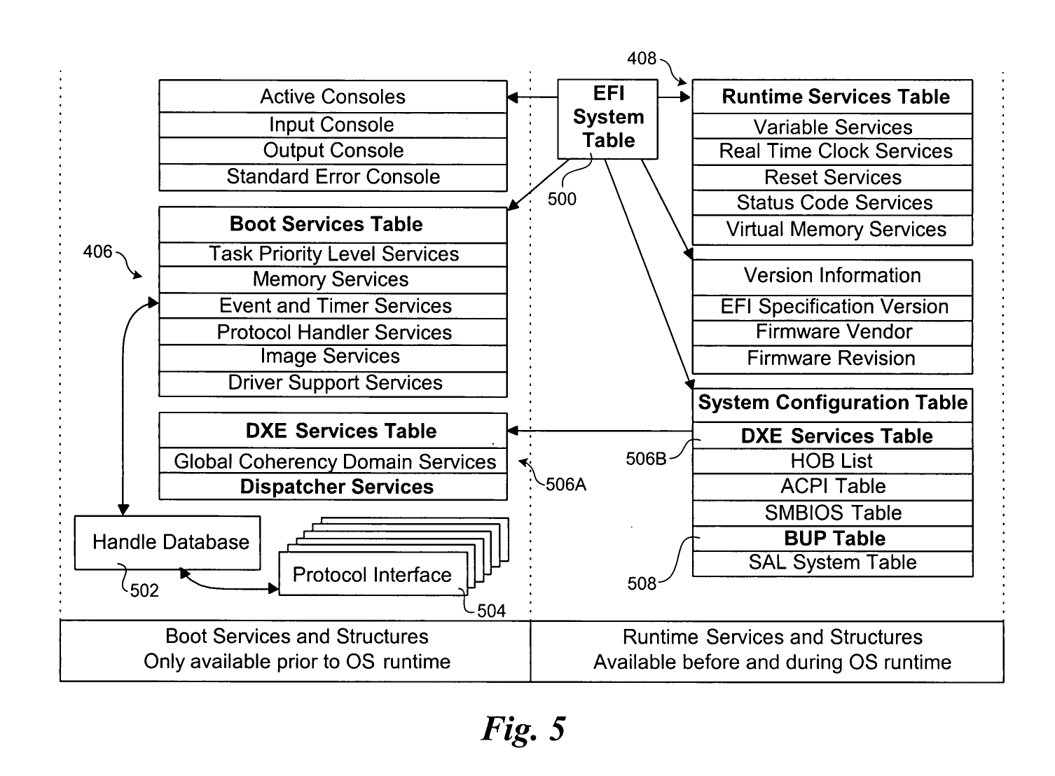

The DXE core produces an EFI System Table 500 and its associated set of Boot Services 406 and Runtime Services 408, as shown in FIG. 5. The DXE Core also maintains a handle database 502. The handle database comprises a list of one or more handles, wherein a handle is a list of one or more unique protocol GUIDs (Globally Unique Identifiers) that map to respective protocols 504. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism). In contrast to Boot Services, Runtime Services are available both during pre-boot and OS runtime operations.

The DXE Services Table includes data corresponding to a first set of DXE services 506A that are available during pre-boot only, and a second set of DXE services 506B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 406, Runtime Services 408, and DXE services 410 are accessed via respective sets of API's 412, 414, and 416. The API's provide an abstracted interface that enables subsequently loaded components to leverage selected services provided by the DXE Core.

After DXE Core 400 is initialized, control is handed to DXE Dispatcher 402. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services.

The second class of DXE drivers are those that comply with the EFI 1.10 Driver Model. These drivers do not perform any hardware initialization when they are executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfigurationTable function. This published drivers are depicted by API's 418. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 420 is used during the BDS phase to enable selection of a Boot target, e.g., an OS to be booted by the system.

During the TSL phase, a final OS Boot loader 422 is run to load the selected OS. Once the OS has been loaded, there is no further need for the Boot Services 406, and for many of the services provided in connection with DXE drivers 404 via API's 418, as well as DXE Services 406A. Accordingly, these reduced sets of API's that may be accessed during OS runtime are depicted as API's 416A, and 418A in FIG. 4.

In accordance with some embodiments, the EFI pre-boot/boot framework of FIGS. 4 and 5 may be implemented to facilitate initialization and run-time support of the foregoing BUP server management functions. This is facilitated, in part, by API's published by respective components/devices during the DXE phase, and through use of the Variable Services runtime service, which is used to update BUP table entries in response to platform configuration changes.

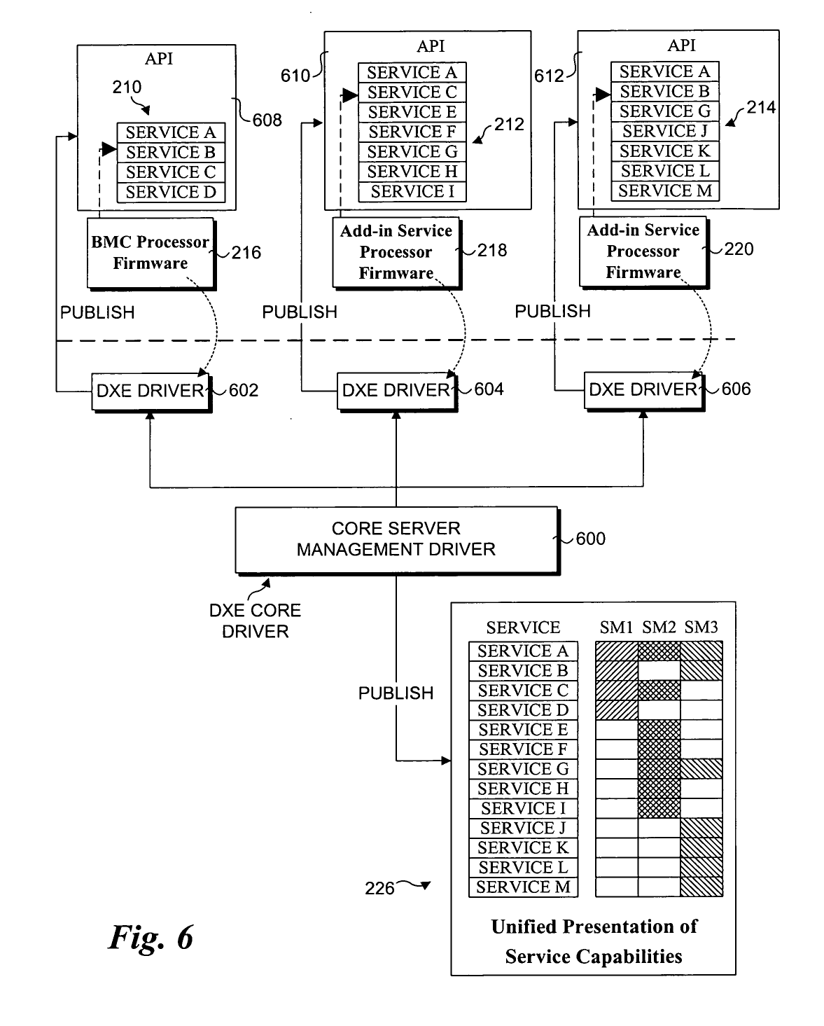

For example, an exemplary scheme for initializing BUP server management facilities is shown in FIG. 6. During the DXE phase, a DXE core server management driver 600 is loaded and executed. In accordance with the framework embodiment of FIG. 2, firmware corresponding to core server management driver 600 comprises a portion of BUP firmware 222. As such, this firmware component is loaded from system BIOS 224.

In modern computer systems, the system BIOS is stored in a memory store called a “boot firmware device” (BFD). BFDs will typically comprise a rewritable non-volatile memory component, such as, but not limited to, a flash device or EEPROM chip. As used herein, these devices are termed “non-volatile (NV) rewritable memory devices.” In general, NV rewritable memory devices pertain to any device that can store data in a non-volatile manner (i.e., maintain data when the computer system is not operating), and provides both read and write access to the data. Thus, all or a portion of firmware stored on an NV rewritable memory device may be updated by rewriting data to appropriate memory ranges (e.g., blocks) defined for the device. Firmware may also be stored in NV memory devices, such as conventional ROMs (read-only memory).

In response to a system reset or power on event, the system performs pre-boot system initialization operations in the manner discussed above with reference to FIG. 3. Upon being reset, the processor executes reset stub code that jumps execution to the base address of the BFD (e.g., a device hosting system BIOS 224) via a reset vector. The BFD contains firmware instructions that are logically divided into a boot block and an EFI core.

The boot block contains firmware instructions for performing early initialization, and is executed by processor 202 to initialize the CPU, chipset, and motherboard. (It is noted that during a warm boot early initialization is not performed, or is at least performed in a limited manner). Execution of firmware instructions corresponding to the EFI core are executed next, leading to the DXE phase. As part of initializing the DXE core is initialized, core server management driver 600 is loaded. In turn, this driver is used to initialize the BUP framework, as discussed above with referenced to block 302 of FIG. 3.

Henceforth, DXE dispatcher 402 begins loading DXE drivers 404. Each DXE driver corresponds to a system component, and provides an interface for directly accessing that component. Included in the DXE drivers are drivers that will be subsequently employed for registering service processors and supporting OS-runtime server management operations. In FIG. 6, these DXE drivers include a DXE driver 602, which is loaded from BMC processor firmware 216, and DXE drivers 604 and 606, which are loaded from add-in service processor firmware 218 and 220, respectively. Loading of DXE drivers 602, 604, and 604 causes corresponding API's 608, 610 and 612 to be published by the EFI framework. In one embodiment, data relating to the BUP is stored in a BUP table 508 of the EFI system configuration table (FIG. 5).

Initially, a DXE driver corresponding to a primary service processor will be loaded, while DXE drivers corresponding to add-in service processors hosted by add-in cards will be subsequently discovered and loaded. In one embodiment, the service processor registration process supports dynamic registration. What this means is that services provided via a “hot-swap” service processor add-in card may be published to the BUP framework, enabling the framework to present any new services offered by the add-in card in its unified list of services. In a similar manner, when a hot-swap add-in card is removed, its corresponding services are likewise removed from the unified list.

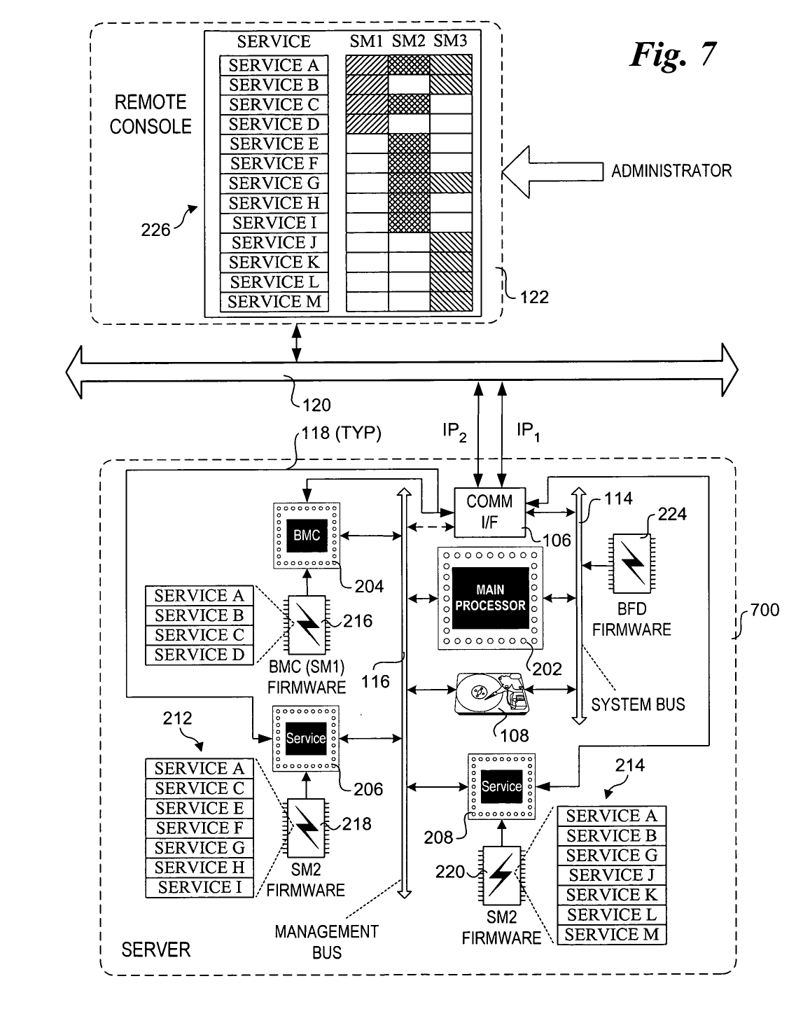

An illustration of a unified presentation of an exemplary set of services offered by various service processors (and associated service code) hosted by a server 700 having a configuration similar to the framework embodiment of FIG. 2 is shown in FIG. 7. In one embodiment, a BUP table 226 includes an aggregated list of services offered by all available service processors for server 700. For example, this would correspond to the left hand column of BUP table 226. In the illustrated embodiment, the BUP table further shows a grid of services vs. service processor. This enables an administrator or the like to select a particular service processor to perform a selected service. This is often advantageous, as it enables the administrator to load-balance the workload performed by the service processors for a given system.

In one embodiment, the administrator or similar end-user is enabled to set up use preferences, whereby a service processor having a higher preference among multiple service processors that support like services is selected to perform the service. For instance, FIG. 7 shows a BUP 226A illustrating one embodiment of a service preference scheme. Under the scheme, an end-user is enabled to set a preferred order of service processors to perform a given task. For example, SERVICE A is supported by each of service processors SM1, SM2, and SM3 (i.e., service processors 204, 206, and 208). It is desired by the end-user to have service processor SM2 perform this task, if available. If service processor SM2 is unavailable, the preference falls to service processor SM3. If neither service processor SM2 or SM3 is available, then service processor SM1 is assigned to perform the service.

In one embodiment, an end-user is enabled to set up preferences during pre-boot system initialization operations. For instance, an EFI application may be employed to present a text-based interface to an end-user of server 700 during its pre-boot phase. In another embodiment, use preferences may be entered during OS-runtime. In this instance, an EFI application or DXE driver is used to publish an API that is available for runtime services. In turn, the API enables a runtime component, such as a system management application to access (i.e., retrieve and/or manipulate) the BUP table data and display such information to an end-user via an appropriate user-interface. Depending on the implementation, the interface presented to the end-user may be either a text-based interface or a graphical user interface.

FIG. 9 shows a flowchart illustrating operations performed during handling of a service management event, according to one embodiment. The processor begins in response to operations performed in a block 900, wherein a service consumer initiates a server management request. In general, a service consumer may comprise any entity that may request server management services to be performed on its behalf. This includes both humans (e.g., administrators) and programmatic entities (e.g., a software-based server management component). In instances in which the service consumer is an end-user, a software-based service host utility may be employed to provide the end-user with service availability and selection operations, along with corresponding information that is displayed while a service is being performed, such as progress, status, results, data dumps, etc. (not shown)

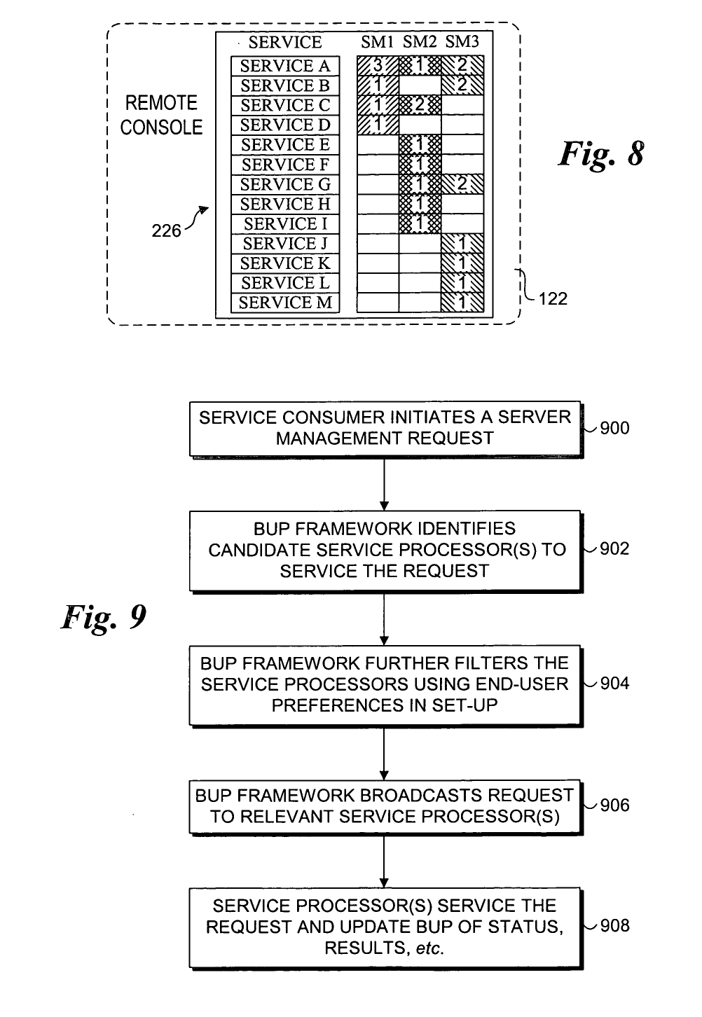

In response to the server management request, the BUP framework identifies one or more (as applicable) service processors that are capable of servicing the request, as depicted in a block 902. If preferences are supported, the BUP framework further filters the selection process based on preferences set up by the end user (such as illustrated in FIG. 8). In a block 906, the BUP framework broadcasts the server management request to the relevant service processor(s). In one embodiment in which preferences are not employed, the broadcast is used to access the first available service processor, thus the broadcast is made to all service processors. Under a preference-based scheme, the broadcast (or a unicast) may be targeted toward a selected service processor with the highest preference. The process is completed in a block 908, wherein the service processor(s) service the request and update the BUP of status, results, etc.

In the foregoing embodiments, firmware and software components are used to support the enhanced server management functions provided by the exemplary BUP framework implementations described herein. Thus, embodiments of this invention may be used as or to support a firmware and/or software executed upon some form of processing core (such as a service processor of a server) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
collecting information pertaining to service capabilities supported by each of a plurality of service processors used to service server management requests for a server, the services supported by each service processor performed via execution of service code associated with that service processor;
aggregating the service capabilities into a aggregated set of service capabilities; and
providing a unified presentation of service capabilities corresponding to the aggregated set of service capabilities to a service consumer.

2. The method of claim 1, further comprising:
collecting the information pertaining to and aggregating the service capabilities supported by the plurality of service processors during a pre-boot phase for the server; and
providing the unified presentation of service capabilities to an end-user via one of a text-based or graphical user interface.

3. The method of claim 2, wherein the unified presentation of service capabilities are provided to the end-user during the pre-boot phase.

4. The method of claim 2, wherein the unified presentation of service capabilities are provided to the end-user during an operating system runtime phase for the server.

5. The method of claim 1, wherein the server includes at least one add-in service processor hosted by an add-in card that installed in the server.

6. The method of claim 5, further comprising:
collecting additional information pertaining to service capabilities of an add-in service processor and associated service code hosted by a hot-swap card that is added to the server while the server is running; and
updating the unified presentation of service capabilities provided to the service consumer to reflect any additional services supported by the added add-in service processor.

7. The method of claim 5, further comprising:
detecting that a hot-swap card hosting at least one add-in service processor and associated service code has been removed from the server while the server is running; and
updating the unified presentation of service capabilities provided to the service consumer to reflect a removal of services offered by the at least one add-in service processor hosted by the hot-swap card that are not offered by any remaining service processor.

8. The method of claim 1, wherein the unified presentation of service capabilities is presented to the service consumer via a BIOS-based application program interface (API).

9. The method of claim 8, wherein the service consumer is a programmatic entity that accesses services via the BIOS-based API.

10. The method of claim 1, wherein the operation of collecting the information pertaining to service capabilities supported by each of a plurality of service processors comprises:
loading firmware drivers for each of the service processors;
enumerating services provided by each service processor via the firmware driver for the service processor; and
publishing the services that are enumerated to a BIOS unified presentation table.

11. The method of claim 10, wherein the operations are performed by firmware components configured in accordance with the extensible firmware interface (EFI) standard.

12. The method of claim 1, further comprising:
enabling an end-user to set preferences for like services offered by more than one service processor; and
in response to a service request;
performing a corresponding service using a service processor with the highest preference from among the more than one service processor.

13. The method of claim 12, wherein the end-user is enabled to set preferences via an interface that is presented to the end-user during a pre-boot phase for the server.

14. The method of claim 12, wherein the end-user is enabled to set preferences via an interface that is presented to the end-user during an operation system runtime phase for the server.

15. An article of manufacture, comprising:
a machine-readable medium that provides instructions that, if executed by a processor in a server, will cause the server to perform operations including,
aggregating service capabilities supported by each of a plurality of service processors used to service server management requests for the server via execution of associated service code; and
providing a unified presentation of service capabilities corresponding to the aggregated set of service capabilities to a service consumer.

16. The article of manufacture of claim 15, wherein the article comprises a non-volatile storage device.

17. The article of manufacture of claim 15, wherein the instructions comprise a portion of the BIOS (basic input/output system) code for the server.

18. The article of manufacture of claim 15, wherein execution of the instructions further performs operations including:
loading firmware drivers for each of the service processors, each firmware driver to enumerate services supported via execution of service code by the service processor to which the firmware driver corresponds; and
publishing the services that are enumerated to a BIOS unified presentation (BUP) table.

19. The article of manufacture of claim 18, wherein execution of the instructions performs the further operation of publishing an application program interface via which a software entity running on the server during an operating system runtime phase for the server is enabled to access data in the BUP table.

20. The article of manufacture of claim 15, wherein the instructions comprise firmware instructions corresponding to firmware components configured in accordance with the extensible firmware interface (EFI) standard.

21. The article of manufacture of claim 15, wherein the server supports runtime installation of hot-swap cards that host at least one add-in service processor and associated service code, and wherein execution of the instructions performs further operations, including:
collecting information pertaining to service capabilities for at least one add-in service processor hosted by a hot-swap card that is added to the server while the server is running; and
updating the unified presentation of service capabilities provided to the service consumer to reflect any additional services supported by the at least one service processor hosted by the hot-swap card that is added.

22. The article of manufacture of claim 15, wherein the server supports runtime removal of hot-swap cards that host at least one add-in service processor, and wherein execution of the instructions performs further operations, including:
detecting that a hot-swap card hosting at least one add-in service processor has been removed from the server while the server is running; and
updating the unified presentation of service capabilities provided to the service consumer to reflect a removal of services offered by the at least one add-in service processor hosted by the hot-swap card that are not offered by any remaining service processor.

23. The article of manufacture of claim 15, wherein execution of the instructions further performs operations including:
enabling an end-user to set preferences for like services offered by more than one service processor; and
in response to a service request;
performing a corresponding service using a service processor with the highest preference from among the more than one service processors.

24. A server, comprising:
a main processor;
a non-volatile storage device in which BIOS instructions are stored, communicatively-coupled to the main processor;
at least one service processor, communicatively-coupled to the main processor; and
for each of the at least one service processor,
a non-volatile storage device in which firmware is stored, the firmware to be executed my the corresponding service processor to perform server management services,
wherein the BIOS instructions, when executed by the main processor, perform operations including:
aggregating service capabilities supported by each of the at least one service processor via execution of firmware corresponding to that service processor; and
providing a unified presentation of service capabilities corresponding to the aggregated set of service capabilities to a service consumer.

25. The server of claim 24, further comprising:
a management bus, to communicatively-couple an add-in service processor hosted by a hot-swap add-in card to the main processor,
and wherein execution of the instructions performs further operations, including,
collecting information pertaining to service capabilities for at least one add-in service processor hosted by a hot-swap card that is added to the server while the server is running; and
updating the unified presentation of service capabilities provided to the service consumer to reflect any additional services supported by the at least one service processor hosted by the hot-swap card that is added.

26. The server of claim 25, wherein execution of the instructions performs further operations including:
detecting that a hot-swap card hosting at least one add-in service processor has been removed from the server while the server is running; and
updating the unified presentation of service capabilities provided to the service consumer to reflect a removal of services offered by the at least one add-in service processor hosted by the hot-swap card that are not offered by any remaining service processor.

27. The server of claim 24, wherein the at least one service processor comprises a baseboard management controller.

28. The server of claim 24, wherein execution of the instructions performs further operations including:
loading firmware drivers for each of the at least one service processors, each firmware driver to enumerate services provided by the service processor to which it corresponds; and
publishing the services that are enumerated to a BIOS unified presentation table.

29. The server of claim 24, wherein execution of the instructions performs further the operation of publishing an application program interface via which a software entity running on the server during an operating system runtime phase for the server is enabled to access data in the BUP table.

30. The server of claim 24, wherein execution of the instructions performs further operations including:
enabling an end-user to set preferences for like services offered by more than one service processor; and
in response to a service request;
performing a corresponding service using a service processor with the highest preference from among the more than one service processors.
